(19) United States
(12) Patent Application Publication
(10) Pub. No.: US 2012/0044416 A1
(43) Pub. Date: Feb. 23, 2012

(54) METHODS AND SYSTEMS FOR MODULAR SINGLE-USE CAMERAS

(75) Inventor: Werner KRACHTUS, Bechtsrieth (DE)

(73) Assignee: MOTIONDRIVE AG, Neustadt a.d. Waldnaab (DE)

(21) Appl. No.: 12/859,212

(22) Filed: Aug. 18, 2010

(51) Int. Cl. H04N 5/225; G03B 17/02

(52) U.S. Cl. 348/375; 396/6; 348/E05.025

(57) ABSTRACT

The present disclosure comprise a digital camera composed of modular units. The digital camera includes a main circuit board equipped with an image sensor or photo clip, and a lens arranged to project an image onto the photo chip. A display, a memory, a power source (e.g., a rechargeable battery), an on/off switch, shutter actuation buttons, and a flashlight are electrically connected detachably with the main circuit board.

### BACKGROUND

The present disclosure relates to a digital camera that may comprise a plurality of technical components, and a housing, wherein the technical components may be received in the housing. Furthermore, the present disclosure relates to processing digital camera exposures.

Conventional single-use or disposable cameras have been available in the market for quite a long time. The cameras may be sold in any kind of shop or outlet location.

They are simply constructed, comprise simple components and are relatively cheap. Usually, single-use or disposable cameras are box cameras with a roll of film installed. Most of them use focus free lenses. Usually they have an inbuilt flash light.

Often they are distributed and used at particular occasions such as celebrations or weddings. There are also cameras available having a watertight housing. They may be used under water for underwater photography while snorkeling or diving. The cameras are particularly popular in situations where a reusable camera would be easily stolen or damaged.

After taking a predetermined number of photographs the whole camera is sent to a laboratory for processing, i.e., for developing the film and producing photographs. Because the film cannot be changed, the housing is opened in the laboratory. After developing the film, the photographs are sent back to the user. The opened cameras are usually disposed, only some of them are recycled, i.e., refilled with film and resold.

However, although the cameras are cheap and handling is easy, there are some serious drawbacks. Due to the use of cheap components, the quality of the photographs is not satisfactory. Furthermore, environmental aspects are not considered in this system as the camera may be made from different materials which may not be separated easily. Moreover, users may want to have more flexibility with respect to the products they obtain and more influence on the design of the product.

Therefore, it is an object of the present disclosure to solve these problems, namely, to increase the quality of single-use cameras, and to consider environmental aspects.

### SUMMARY

A digital camera according to the present disclosure may comprise: a plurality of technical components; and a housing, wherein the technical components may be received in the housing; wherein the camera has a modular configuration.

The technical components may be provided as modules that are easily exchangeable whenever required. For example, if there is a defect in one of the modules, it may easily be exchanged. Furthermore, if the owner of the camera wishes to amend single components, he/she may detach the respective module and replace it with a better module. For example, it is known that the development of digital components is very fast. The capability of single components is increased within a very short time. In the present disclosure, the owner may exchange components whenever better components are offered in the market.

The present disclosure may allow a provider to provide digital cameras for single-use applications. The camera itself may be a multi-use device within the system. The provider may be a provider for cameras in combination with digital photography services, i.e., after a single-use cycle the provider may receive the camera from the user and process the digital image data. The provider may, e.g., produce a photobook and send it to the user. In this closed circle (wherein the multi-use cameras circulate in single-use cycles) the camera according to the present disclosure may offer particular advantages as to maintenance and availability of digital cameras.

The housing may be detachable from the technical components. Thus, the housing may be exchangeable.

The housing may be a disposable or single-use housing. The camera may be designed for being used in a single-use system as described later in this application. In the single-use system, a single-use housing may be provided which may be exchanged after one or several multi-use cycles, whereas the other components received in the housing may be multi-use components. Thus, the quality of the technical components may be improved as their lifetime is longer than with conventional disposable cameras.

Furthermore, the design of the housing, e.g., customized design, for weddings, etc., and the functionality of the housing, e.g., watertight edition for diving, may be varied. The housing may be exchanged according to demand, whereas the technical components may be re-used. The housing may be detachable from the other technical components by the provider of the camera and is thus exchangeable.

In some embodiments of the present disclosure, the technical components may include at least a first module comprising an optical system, a second module comprising an image sensor, a third module comprising a power source, a fourth module comprising a memory for storing image data, and a fifth module comprising a shutter actuation unit having at least one actuator button.

The modules may be provided as units having a housing that houses the technical elements of the unit, or partitions to keep the technical elements of the unit separated from the technical elements of an adjacent unit. The modules may also have terminals for connecting a module with other modules or a central circuit board.

The technical components of the digital camera may be configured as modules that are connectable to a circuit board or to other modules. The main components may be an optical system, i.e., a camera lens or objective for focusing the picture in an image plane, an actuator device, i.e., a shutter actuator having a shutter button (which is, of course, accessible and may protrude from the housing), and an energy source, e.g., a battery or rechargeable battery or accumulator; an image sensor, e.g., a light sensitive chip; a memory for storing image data; and a monitor for displaying images. Furthermore, there may be a logical unit, e.g., a controller; an RGB filter; high- and low-pass filters; and ND converters.

The digital camera may be a compact camera or an SLR camera. However, for single-use applications, cameras having simple components, cost-effective cameras, and/or cameras providing easy handling may be preferred.

The sensor unit may comprise a CCD sensor on a circuit board or a CMOS sensor.

The capacity of the energy source/power source may determine the maximum operating time of the camera. If the single-use camera is configured not to allow exchanging or recharging the power source, the energy source may be used to delimit a single-use phase of the single use camera, i.e., as soon as the power source is empty, the camera may not allow further operation and may be sent back to the provider who opens the housing, transfers data from the internal memory to an external device and processes them. For example, the provider may create a product, e.g., a photobook, any other printed matter, an item having a photo printed thereon, and send it back to the user.

The memory may be a memory card, e.g., a compact flash memory card or a removable card (which may only be removable when the housing has been removed from the technical components).

A digital camera may be a camera for taking photographs, but it may also have a functionality of taking film sequences. Also, the camera may be a camcorder. It is noted that in this application the term “camera” may be used for all these possibilities.

In some embodiments, the fifth module may have at least two actuator buttons, or exactly two actuator buttons, arranged at different sides of the housing. One of the buttons for actuating the shutter of the camera may be arranged on the top surface of the camera housing as it is provided in conventional camera designs. The other button may be arranged at the rear surface of the camera housing. The two buttons can allow easy handling of the camera when taking horizontal pictures and when taking upright pictures. Whereas the first button may be arranged for comfortable actuation when taking horizontal pictures, the second button may be used for taking upright pictures because it may be in a better position for that purpose. Particularly when using a camcorder (which is also considered to be a “camera” in the sense of the present application) this feature has advantages because camcorders are often used with one hand only.

The technical components may include a sixth module comprising at least one of a viewfinder and a monitor. In simple single-use cameras, the viewfinder may comprise one or two plastic lenses (one of them may be at each side of the housing). The exposure image may be seen in the viewfinder lens. In some embodiments, the camera may include a monitor which may fulfill the functionality of a viewfinder and also display images already taken. The monitor (or display) may be small and thus quite cheap when it is particularly used as a viewfinder.

The technical components may include a seventh module comprising a switch unit having a switch for on/off actuation of the camera.

The technical components may include an eighth module comprising a flashlight. Depending on the application, the housing may be designed to either allow flashlight functionality or not. A flashlight may, in the modular configuration of the present disclosure, be optionally provided or not by simply connecting the module or not.

The technical components may be multi-use components. Whereas the housing may be for single-use or even disposable, the technical components may be used for several cycles of single use. It is not believed that a single-use housing in combination with multi-use technical components has been offered in this field of business so far.

The digital camera may include a main circuit board for connecting a plurality of modules (namely all electronic modules) to the main circuit board. The modules may be connected with the circuit board or with each other detachably, e.g., by suitable connectors. In some embodiments, the digital camera may include a main circuit board, wherein the modules may be detachably connected to the main circuit board. The camera may include connectors for detachably connecting modules to the main circuit board.

The technical components (and the circuit board) may be fixed to a carrier construction. Thus the technical components may not fall apart after removing the housing, but may keep in defined relative position to each other. So the components may be positioned in any other housing and enclosed therein.

Due to the modular construction of the camera, the modules may be exchangeable.

The housing (single-use/disposable or for use in a limited number of cycles) may have a customized design. The shape and the imprint of the housing may be adapted to particular occasions. For example, for weddings, the colors of the housing may be adapted to fit the colors of the wedding location, or the design may be adapted to comply with the theme of a celebration. At least the design is variable and many different designs may be offered. Because the housing is single-use, the design of the cameras may be amended and varied according to market demand very easily in a closed circle system according to the present disclosure. The housing may be made of any material, particularly resin material, that complies with technical requirements like stability, protection against impact, dust and water, etc. and that is compatible with the design of the product of the present disclosure.

In some embodiments of the present disclosure, the camera may be configured for taking a limited number of exposures and for recording a limited time of film sequences, respectively, during a particular single-use cycle. This may be required for the application of the camera when being used in a single-use cycle system. Furthermore, the camera may be configured for being reset after the housing has been removed from the technical components for allowing taking another sequence of a limited number of exposures and for allowing recording another limited time of film sequences, respectively. So the technical components of the camera, except for the housing, may be applied in many single-use cycles.

A system for processing digital camera exposures according to the present disclosure may comprise a provider providing digital cameras as described above. The provider may provide multi-use cameras in a closed circuit single-use system. The system may comprise a network including a provider station for providing digital processing services and at least one user station connected to the provider station. The camera of the present disclosure may be advantageous for the application in a system, wherein a provider provides both single-use cameras and digital processing services in a closed circuit system. Because the system refers to a single-use camera system, it may be advantageous that the provider provides the cameras to the users, collects them to process the photographs after a single-use cycle, and determines the housing for a new cycle of the camera.

Any of the modules of said digital camera may be exchanged at various occasions when the camera circulates back to the provider, e.g., when there is a failure of said module, when a predetermined lifetime of the component has expired, when a module of said digital camera is to be exchanged with a module having better quality, etc. There may be technical reasons for exchanging modules, e.g., when there are new components available having a longer life, better capability, durability, stability, etc.

In some embodiments, the provider station may store camera exposures taken with said digital camera and allow access to said digital camera exposures upon input of an individual user identifier. The camera and the user identifier may be provided as a set before using the camera during a single-use stage.

In some embodiments, a method of providing digital photography services to a user according to the present disclosure may comprise a provider offering in combination a. a digital camera or digital camcorder for taking photographs or film sequences during a single-use phase; and b. at least one of digital photography processing services and a product based on the photographs taken by the user and returned to the provider.

The price for an offer, (package) may substantially correspond to the price of the services/products included in the offer. However, the services/products included in the offer may only be claimed after returning the camera or camcorder to the provider. Thus the price paid for the package before claiming the services/products may include in the offer a deposit for the camera. Therefore, there may be a high incentive to return the camera to the provider after a single-use phase. The camera may be left to the user free of charge (or for a certain amount for renting the camera) for a single-use range. The provider may “lend” the camera to the user when selling the package upon a deposit which is the price for the services. It may be a feature of the present disclosure that the provider does not make a loss even when the user keeps the camera, hacks the camera, etc. The value of the camera/camcorder and the value of the services/products may substantially correspond. Small variations of the price, e.g., for compensating for administrational cost, additional charge for risk of having to repair or replace cameras, etc., may be within the scope of the present disclosure. However, the user may have the feeling or belief that he/she does not pay at all for the camera, but only for the services which he converts in exchange for the camera after his/her particular single-use phase.

Another aspect of the present disclosure may be that the provider of the camera/camcorder is also the provider of the services/products acquired together with the camera/camcorder. In conventional systems, a disposable camera could be sent to any laboratory for developing the film. The laboratory charged extra for their services. In the present disclosure, selling the package may include providing a camera on a loan basis and selling digital photography services like printing books. All the steps may be carried out and administered by the same provider, i.e., the system and method are a closed circuit. A single-use cycle system and method may be provided, wherein the cameras circulate to be used during single-use cycles. The plurality of cameras may be circulated in the closed circuit. For example, a first part of the plurality of cameras may be distributed among another plurality of users taking photos in their particular single-use phase. Another part of the plurality of cameras may have been returned from users to the provider for producing selected items or for carrying out selected services. Another part of the plurality of cameras may have been reset for another single-use phase and offered in a shop or in any other sales location to customers who are interested in acquiring the package of camera and other products/services. In the closed circuit, there may be just a single payment transaction, for example when the user buys the package.

Furthermore, the method may combine services and advantages of single-use cameras and digital photography services, e.g., ordering a photobook, in a very simple manner. A user may make a decision about the product when buying the package, e.g., when there is a choice of different packages for different services, he/she may make a decision when returning the camera to the provider by filling in a order card, and/or after retrieving (and selecting/processing) the data in the provider's access area in a global network.

The single-use phase may be defined by a restriction of the number of photographs to be taken with the camera or the exposure time for film sequences to be taken with the camcorder. The digital camera or the digital camcorder may have a limited capacity of exposures and recording time, respectively, during a single-use phase. The camera may be a single-use camera or a reusable camera having a limited number of exposures to be taken during a single-use stage or a limited recording time for film sequences to be taken during a single-use stage. In some embodiments of the present disclosure, the capacity of the camera/camcorder may be limited by the charge state of the power source, e.g., the accumulator, battery, rechargeable battery, etc. As long as the power source is charged, exposures and films may be taken. If the charge state is “empty,” the camera may need to be returned because the camera may be configured that the user is not enabled to re-charge the power source or change the battery. For example, the battery may be integrated within the housing of the camera without access for the user. The power source and the other technical components may also be encapsulated in the housing. In some embodiments of the present disclosure a set of power sources that are particularly suitable and fitting in the camera may be provided at the time of acquiring the camera.

Furthermore, the cameras circulating in the closed circuit of the system/method according to the present disclosure may include an ID chip, e.g. RFID chip, or any other identification device such that the pictures taken and returned to the provider by a particular user can be unambiguously attributed to the user. As pictures may be considered very private and personal it is important to avoid any confusion of users and picture sets. An ID chip which may be connected with the camera may allow identifying a set of image data when the camera is returned to the provider until the product is sent to the user. The system may be configured such that an order form filled in by a user (or any personal data, e.g., name, address, etc., provided by the user,) comprises a first code and the ID chip comprises the same or another code which is attributed to the first code. Thus, customer/user data and a camera returned by this particular customer/user may always be attributed to the personal data of the user even though during the technical process the camera may be separated from the order form or from the data provided by the user.

In some embodiments of the present disclosure, the digital camera or the digital camcorder may be a multi-use camera and a multi-use camcorder, respectively, which may be used in several subsequent single-use stages/phases, i.e., in several subsequent cycles of single-use applications. Thus, the quality of the components may be improved compared with disposable cameras. Furthermore, an improvement may be achieved by digital technology and processing. Furthermore, “recycling” may be very easy because it is accomplished by simply providing memory space for the next single-use stage. This can be done by deleting data from a memory or by resetting the camera.

A software solution may be implemented in the logical circuit of the camera. It may deny user access to the internal memory of the camera or it may encode exposure data stored in the internal memory of the camera. Only the provider may be able to deactivate the blocking or to decode the data.

A hardware solution may comprise a mechanical blocking of a link or an interface provided in the camera. Whereas the internal memory of the camera is blocked against access by the user, the provider may have a “key” to unlock the download functionality. For example, the “key” may be a tool for breaking or opening the housing of the camera in order to obtain access to the memory card, a link, an interface, etc. However, the housing may just be an encapsulation which may be opened by applying force, or by applying a special tool for opening, e.g., screws or bolts to open the housing. Another possibility is that the housing may be destroyed by the provider in order to be able to access the memory and the housing may be replaced for the next single-use stage (i.e., the housing may be a single-use housing, whereas the other components of the camera may be multi-use components).

In some embodiments of the present disclosure, the method may include providing in said combination a voucher for claiming said photography processing services and said product.

The product may include that a photograph taken is provided as data stored on a recording medium such as a DVD, a CD or online in a print format. Or the product may be printed matter, e.g., a photobook, an album, etc.

The digital camera and the digital camcorder, respectively, may be offered in a receptacle or together with a receptacle for receiving the digital camera and digital camcorder, respectively, after termination of the single-use phase, and returning it to the provider. After having taken pictures, the user may return the camera to the provider. The receptacle may comprise a field, e.g., including a stamp, indicating that the correct postage has been paid (which may be included in the purchase price for the offer).

Payment of the combination may be effected at the time or before the time of handing over the camera and camcorder, respectively, to the user so that the user may not pay for the camera directly, but for the services/products included in the offer. The purchase price may be used as (or include) a deposit for the camera until it is returned to the provider (i.e., the user may have to return the camera or camcorder before claiming digital photography processing services and a product included in the offer).

The camera may have a functionality of taking photographs and film sequences. The offer may be adapted to this functionality by providing a camera which is configured for recording a combination of pictures and film sequences until a predetermined capacity is used.

A system of providing digital photography services to a user may comprise a provider offering in combination a. a digital camera or digital camcorder for taking photographs or film sequences during a single-use phase; and b. at least one of digital photography processing services and a product based on the photographs taken by the user and returned to the provider; wherein the provider may have a camera distribution unit for distributing cameras in a distribution system, a receiving unit for receiving cameras returned by the users, a processing unit for processing exposure data provided by the users, and a memory for storing exposure data.

### BRIEF DESCRIPTION OF THE DRAWINGS

FIG. 1 illustrates an embodiment of a camera according to the present disclosure in a side perspective view.

FIG. 2 illustrates the embodiment of the camera of FIG. 1 in a rear perspective view.

FIG. 3 illustrates technical components of a digital camera according to the present disclosure.

FIG. 4 illustrates schematically the connection of technical components of a camera according to the present disclosure.

FIG. 5 illustrates another embodiment of a digital camera according to the present disclosure.

FIG. 6 illustrates handling of the digital camera shown in FIG. 5.

FIG. 7 illustrates a schematic view of a system according to the present disclosure.

FIG. 8 illustrates a flow chart showing a method according to the present disclosure.

### DETAILED DESCRIPTION

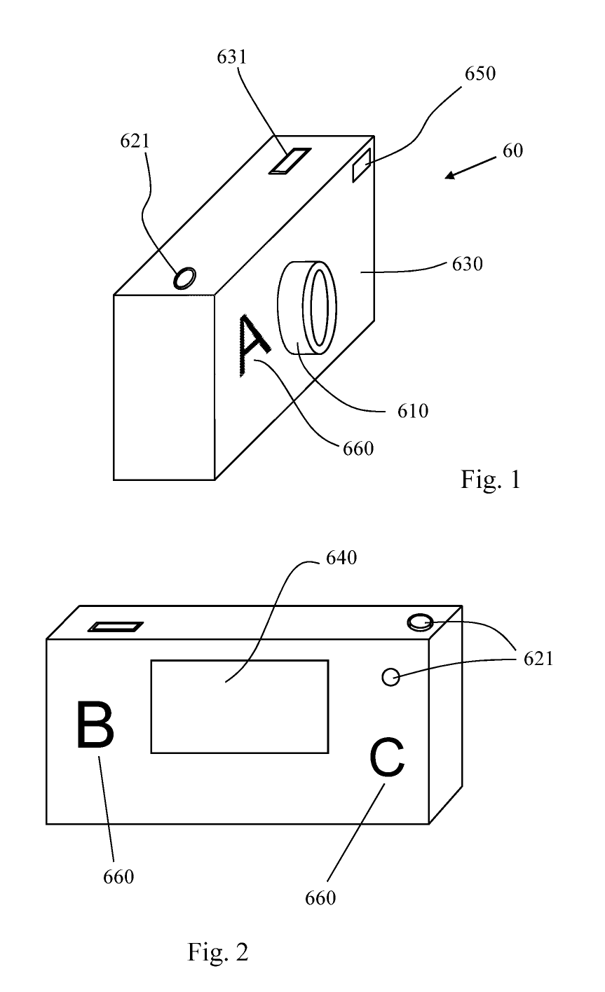

FIG. 1 and FIG. 2 illustrate an embodiment of a digital camera 60 according to the present disclosure from two different views.

The digital camera 60 may comprise a housing 600 made of resin or any similar plastics materials. The camera 60 may have a camera lens 610, and actuator buttons 621 arranged on the top surface of the housing 60 and on the rear surface of the housing. Furthermore, the camera may include a display 631 showing the number of exposures that have already been taken. Provided on the rear side of the camera 60 may be a monitor 640 for displaying images and for being used as a viewfinder. On the front side of the camera 60 there may be a flashlight 650. Reference numeral 660 may indicate design options for the disposable housing 600.

In an embodiment shown in FIG. 2, the camera may have two actuator buttons 621 for actuating the shutter of the camera. A first button 621 may be arranged on the top surface of the camera housing 600, and a second button 621 may be arranged at the rear surface of the camera housing 600. The two buttons 621 may allow easy handling of the camera when taking horizontal pictures and when taking upright pictures. Whereas the first button may be arranged for comfortable actuation when taking a horizontal picture, the second button may be used for taking upright pictures because it is in a better position for that purpose. This feature may be particularly useful in connection with camcorders (not shown, but the term “digital camera” is used synonymously with the term “digital camcorder” in the present application). But also when being provided in a camera, this feature may be useful in situations when the user holds the camera with one hand only, e.g., during a roller coaster ride or at a party.

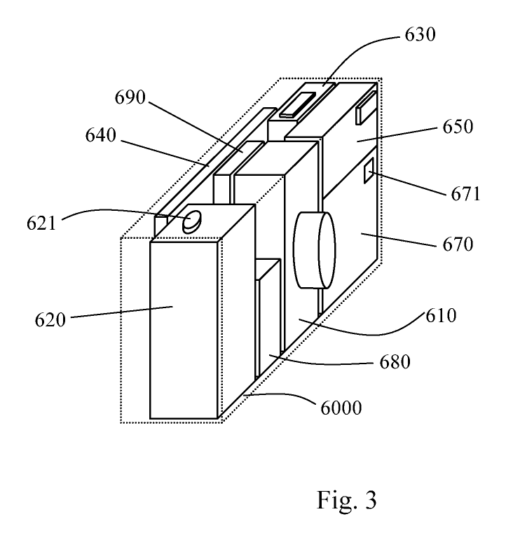

FIG. 3 shows technical components of the camera 60, which may include an optical system 610 including the optical lens, an actuator unit 620 including an actuator button 621, a display unit 630 indicating information, e.g., a number of pictures, an image sensor unit 690, a flashlight unit 650, a memory unit 670 for storing image data, an energy source unit 680, and a monitor unit 640 for displaying images. Another feature illustrated in FIG. 3 is that there may be at least one interface 671 for transmitting data from the memory 670 to an external memory.

There may be further elements like cables for connecting components, a controller unit, an RGB filter, high- and low-pass filters, A/D converters, etc. These are known components of conventional digital cameras. The technical components as described may be fixed to a support 6000. In this embodiment, the support 6000 is a support plate, but it may have any other configuration for holding the technical components in a predetermined position after removal of the housing. The technical components may be re-usable, i.e., they form a multi-use module, whereas the housing may be a single-use tool. Furthermore, there may be a main circuit plate (not shown). The technical components may be detachably connected to the main circuit plate.

The technical components may be provided as modules which can be separated from each other. They may be encapsulated sub-units which are exchangeable.

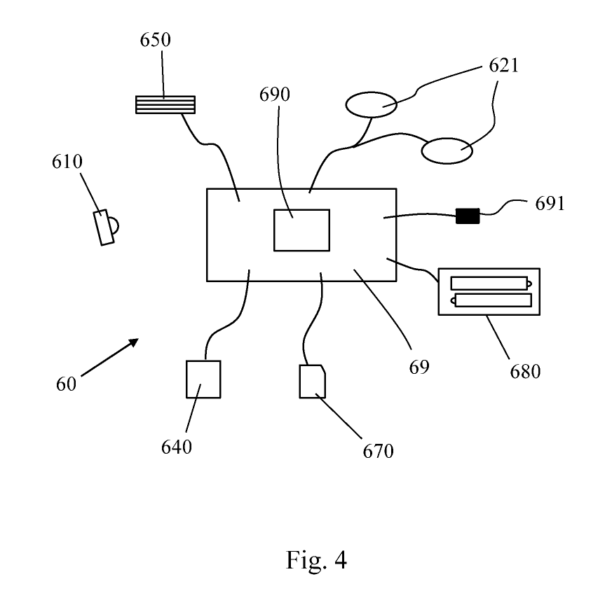

FIG. 4 is a schematic illustration of technical components of a camera according to the present disclosure. A main circuit board 69 may be equipped with an image sensor 690 (photo chip). Furthermore, a lens 610 may be arranged to project an image (real image) onto the photo chip 690. A display 640, a memory 670, a power source (e.g., a rechargeable battery) 680, an on/off switch 691, shutter actuation buttons 621 (two in this embodiment), and a flashlight 650 may be electrically connected with the main circuit board 69. The modules may be connected detachably with the main circuit board 69.

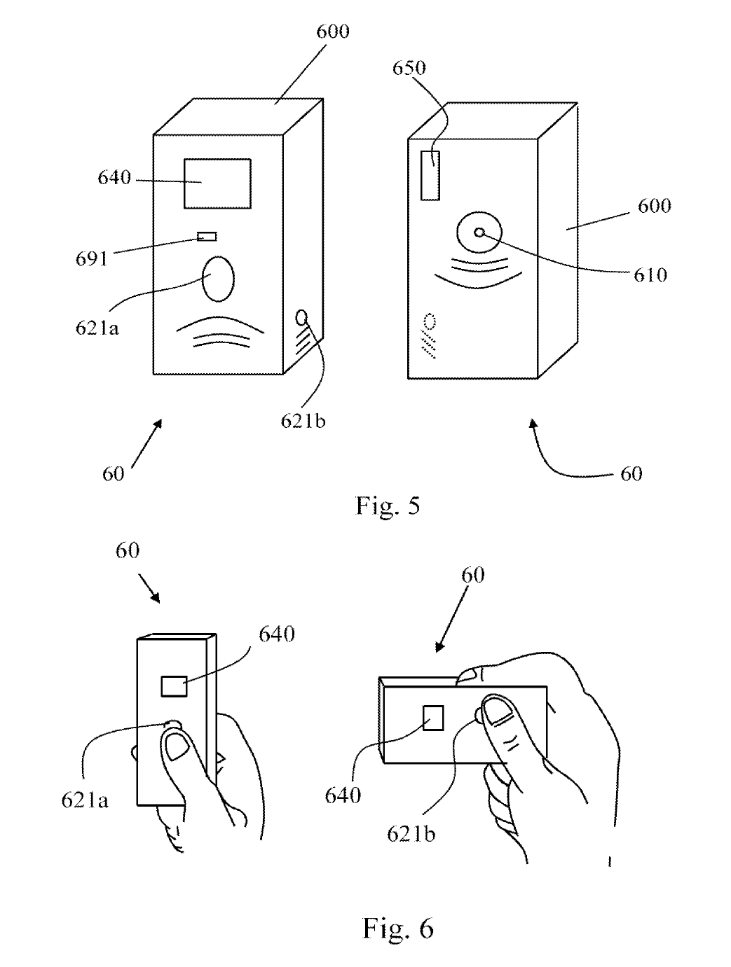

FIG. 5 shows different views of another embodiment of a camera 60 or camcorder according to the present disclosure. On the rear side of the housing 600 may be arranged an on/off button 691, a small display 640, and a first shutter actuator 621a. A second shutter actuator 621b may be provided on the top side of the housing 600. The front side of the housing 600 may comprise a lens 610 and a flashlight 650.

The two buttons 621a and 621b may allow easy handling of the camera 60 when taking horizontal pictures and when taking upright pictures as shown in FIG. 6. When taking a picture in an upright alignment of the camera 60 (left side), the first shutter actuator 621a may be actuated. When taking a picture in a horizontal alignment of the camera 60 (right side), the second shutter actuator 621b may be actuated. The monitor or display 640 may be used as a viewfinder and completely visible, and cannot be concealed by the user's hand.

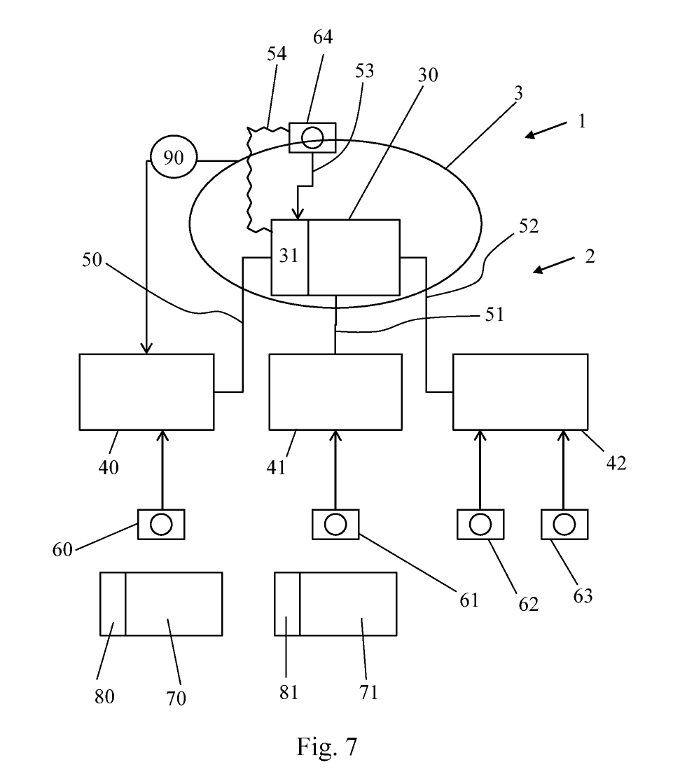

Reference is made to FIG. 7 showing a schematic view of a system according to the present disclosure. A system 1 may comprise a network 2, e.g., a global network like the internet, and a provider 3.

The provider 3 may have a provider station 30 which is included in the network 2. Furthermore, the network 2 may comprise a plurality of user stations 40, 41, 42 which may be connected to the provider station 30 via cable connections 50, 51, and 52, respectively. However, in another embodiment of the present disclosure, the connections may be wireless connections.

The user stations 40, 41, 42 may be computers, mobile phones, notebooks or any other electronic device being connected to the provider and having a user interface.

The system 1 may comprise a plurality of digital cameras 60, 61, 62, 63, and 64. Cameras 60, 61, 62 and 63 may be attributed to users 40, 41, and 42, respectively, as indicated by arrows. A further camera 64 may be just connected to the provider station 30.

The digital cameras 60, 61, 62, 63 and 64 may be designed to be used in a single-use stage. (i.e., each of the cameras 60, 61, 62, 63 and 64 may have a limited number of exposures to be taken before the camera is sent to the provider 3.). For example, the number of exposures may be limited to 24 or 36 exposures. After the maximum number of exposures has been taken, the camera may be disabled to take any further pictures. The number of exposures may be limited by software implementation or by a limitation of the capacity of the memory card of the camera.

The cameras may be disposable cameras. The cameras may also be re-usable after a single-use range for a next single-use range (i.e., the cameras may form a system of reusable cameras). After the data have been transferred from the memory of the camera to the memory 31 of the provider station 30, the memory of the camera may be deleted to provide memory for the next (and sometimes limited) number of exposures. It may also be possible to activate the memory for a new single-use range and thus enable the memory to overwrite data stored in the memory of the camera.

Furthermore, the cameras 60, 61, 62, 63 and 64 may be configured to prevent access to the memory of the camera. For example, the cameras 60, 61, 62, 63 and 64 may be configured to prevent transfer or downloading of the exposure data from the memory. This configuration may be implemented by providing no accessible interface or link for connecting the camera to an external memory. In another embodiment, the interface or link may be locked in order to prevent users from accessing data stored in the camera.

Only the provider 3 may be able to access and download the stored data to a memory 31 of the provider station 30 as shown in FIG. 1 with respect to camera 64. The data transfer may be enabled by unlocking an interface or a link. Unlocking may be provided by changing settings in the software of the camera, by unlocking a mechanical lock, e.g., by opening a cover portion of the housing or by destroying the housing of the camera, etc. Furthermore, the data stored in the camera may be encoded. Only the provider may be able to decode the data after a data transfer to memory 31. The data transfer may be accomplished by a cable connection 53 or wireless, e.g., by wireless LAN 54. Any encoding/decoding method may be considered to provide a lock for disabling unauthorized users to transfer data. If image data are stored as encoded data in the memory of the camera, a further advantage may be that in case of loss of the camera there is no risk that the images may be seen by uninvolved persons.

Furthermore, the system 1 may comprise receptacles 70, 71, e.g., a box, a bag or a pouch, provided with the cameras 60 and 61, respectively. The cameras 60, 61 may be received in one of the receptacle 70, 71 when being acquired by a user 40, 41. In the receptacle 70, 71, there may be a code 80, 81 or a voucher 80, 81. The code 80, 81 may allow accessing the provider station 30 to retrieve pictures taken with camera 60 and 61, respectively, from the memory 31 of the provider station 30. The provider station 30 may provide further functionalities enabling the user to process the pictures, to select pictures, to order selected pictures, to order a photobook or an album including selected pictures, etc. The code or voucher 80, 81 may be used to order printed photographs or a recording medium 90 such as CD or DVD with the photographs recorded thereon in a print format. The recording medium may also include software for further processing the photographs.

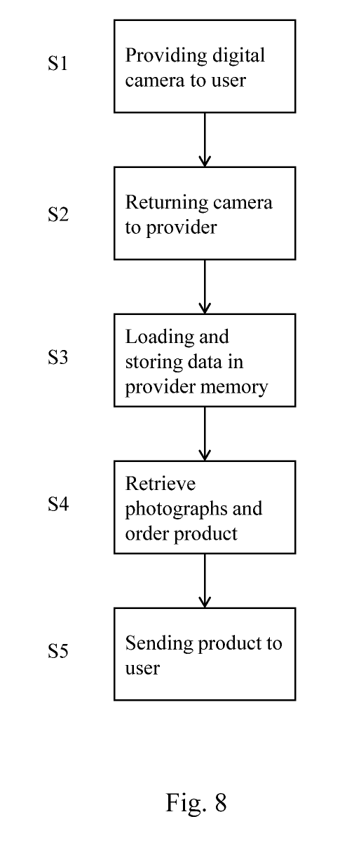

FIG. 8 illustrates a method according to the present disclosure.

In a step S1, a provider may provide, e.g., in a shop, digital cameras to be acquired by users. The camera may be received in a receptacle which also includes a code and/or a voucher. Instead of a single camera, a set of cameras may be offered to the user. When the user pays for the camera, he/she may acquire a package of goods/services including processing of the pictures by the provider as well as producing and sending products such as photobooks, printed matter, or other items (like cups, T-shirts, etc.), including selected photographs taken with the camera.

In a step S2, after the user may have taken a (perhaps limited) number of photographs, the camera may be returned to the provider. The provider may load and store, in a step S3, image data from the camera to a provider memory.

In a step S4 the user may, via a user station, retrieve the image data sent to the provider upon entering the code. He may select a number of photographs, create a photobook or an album, process the images, etc. Afterwards, he may order particular products (e.g., a photobook, printed hardware, a data storage medium such as a CD or a DVD) including the selected photographs. The order may be sent directly via the network after logging in the access area of the provider station by entering the code. Alternatively, the voucher may be cashed for ordering the product.

In a step S5, the ordered product may be produced and sent to the user. Alternatively, the product may be provided online to be downloaded by the user and printed out or stored at the user station.

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, but neither require nor exclude two or more such elements. Further, ordinal indicators, such as first, second, or third for identified elements are used to distinguish between the elements; they do not indicate a required or limited number of such elements, and do not indicate a particular position or order of such elements unless otherwise specifically stated. Any aspect shown or described with reference to a particular embodiment should be interpreted to be compatible with any other embodiment, alternative, modification, or variance.

We claim:

1. A digital camera, comprising:
a plurality of technical components; and
a housing, wherein the technical components are received in said housing;
wherein said camera has a modular configuration.

2. The digital camera of claim 1, wherein said housing is detachable from said technical components.

3. The digital camera of claim 2, wherein said housing is a disposable housing.

4. The digital camera of claim 1, wherein said technical components include at least a first module comprising an optical system, a second module comprising an image sensor, a third module comprising a power source, a fourth module comprising a memory for storing image data, and a fifth module comprising a shutter actuation unit having at least one actuator button.

5. The digital camera of claim 4, wherein said fifth module has at least two actuator buttons arranged at different sides of said housing.

6. The digital camera of claim 4, wherein said technical components include a sixth module comprising at least one of a viewfinder and a monitor.

7. The digital camera of claim 6, wherein said technical components include a seventh module comprising a switch unit having a switch for on/off actuation of the camera.

8. The digital camera of claim 7, wherein said technical components include an eighth module comprising a flashlight.

9. The digital camera of claim 4, wherein said camera includes a main circuit board for connecting a plurality of said modules to said main circuit board.

10. The digital camera of claim 9, wherein said camera includes connectors for detachably connecting said plurality of modules to said main circuit board.

11. The digital camera of claim 4, wherein said camera includes a main circuit board, wherein a plurality of said modules are detachably connected to said main circuit board.

12. The digital camera of claim 10, wherein said camera includes connectors for detachably connecting said plurality of modules to said main circuit board.

13. The digital camera according to claim 1, wherein said technical components are multi-use components.

14. The digital camera according to claim 4, wherein said modules are exchangeable.

15. The digital camera of claim 1, wherein said housing has a customized design.

16. The digital camera of claim 1, wherein said camera is configured for taking a limited number of exposures and for recording a limited time of film sequences, respectively.

17. The digital camera of claim 16, wherein said camera is configured for being reset for allowing taking another sequence of a limited number of exposures and for allowing recording another limited time of film sequences, respectively.

18. A system for processing digital camera exposures, comprising a provider providing digital cameras according to claim 1.

19. The system of claim 18, wherein said system comprises a network including a provider station for providing digital processing services and at least one user station connected to the provider station.

20. The system of claim 18, wherein a module of said digital camera is exchanged when there is a failure of said module.

21. The system of claim 18, wherein a module of said digital camera is exchanged when a predetermined lifetime of the component has expired.

22. The system of claim 18, wherein a module of said digital camera is exchanged with a module having better quality.

23. The system of claim 19, wherein said provider station stores camera exposures taken with said digital camera and allows access to said digital camera exposures upon input of an individual user identifier.

24. The system of claim 23, wherein said camera and said user identifier are provided as a set before using the camera during a single-use stage.
